(19) United States
(12) Patent Application Publication
(10) Pub. No.: US 2004/0040924 A1
(43) Pub. Date: Mar. 4, 2004

(54) Mobile crane comprising a telescopic jib

(76) Inventor: Christian Reifenscheid, Zweibrucken (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/466,733

(22) PCT Filed: Jan. 18, 2002
(86) PCT No.: PCT/DE02/00213

(51) Int. Cl. B66C 23/26

(52) U.S. Cl. 212/175

(57) ABSTRACT

The invention relates to a mobile crane comprising a telescopic jib (1) that can be telescopically extended by means of a drive located on the inside, has a basic box section (6) that is connected via a rotary joint (2) to the superstructure (7) of the mobile crane (10) and has one or more sections (inner box sections 3, 4, 5) that can be extended and retracted telescopically and, by means of a tilting cylinder (8), can be erected from a substantially horizontal position for the transport into a working position, the telescopic jig (1), when retracted telescopically, being longer than the length of the chassis L_{F} and at least substantial telescopic parts of the telescopic jib (1), when retracted telescopically, being displaceable rearward in the substantially horizontal position with respect to the superstructure (7). The invention achieves the object, while maintaining the greatest possible length that can be extended telescopically from the telescopic jib, and without the necessary to release the rotary bearing on the base box frame of not permitting the overhang of the telescopic jib with respect to the chassis of the mobile crane to exceed the permissible dimension in the transport position and keeping the expenditure on construction for this purpose as low as possible.

### DESCRIPTION

The invention relates to a mobile crane comprising a telescopic jib according to the preamble of patent claim 1.

DE-AS 1 261 992 discloses a mobile crane comprising a jib that can be extended telescopically by a drive and which has a basic box section formed in the manner of a grid, which, in the working position, is connected by a rotary joint to the superstructure of the mobile crane, which can be pivoted about a vertical axis. Mounted in this basic box section is a jib section that can be extended and retracted telescopically. In order to transport the mobile crane, the telescopic jib is mounted substantially horizontally on the superstructure. The rotary joint for fixing the basic box section is in this case released, and the entire jib can be displaced a considerable distance rearward as compared with its working position, so that the front overhang of the jib with respect to the chassis of the mobile crane is substantially smaller in the transport position than the overhang which results immediately after the telescopic jib has been lowered from its working position.

A similar mobile crane, constructed as a goliath crane, is also disclosed by DE 39 15 518 A1, in which a plurality of inner box sections (telescopic sections) can be extended telescopically from a basic box section. The telescopic jib can in this case be erected into its working position by a tilting cylinder from its substantially horizontal position during transport. In order in this case as well to reduce the overhang of the telescopic jib beyond the front end of the chassis of the mobile crane to a permissible extent, without reducing the jib length in the process, i.e. to keep it as great as possible, provision is also made in the case of this mobile crane to release the rotary joint with which the telescopic jib is held in the working position, in order to achieve the transport position, so that horizontal displacement of the entire telescopic jib can be carried out. In order to permit this displacement, special rollers are provided to guide the telescopic jib on the superstructure. The displacement of the jib rearward into the transport position is performed with the aid of the hydraulic tilting cylinder. The disadvantage of this solution is that, on the one hand specific structural precautions have to be provided in the form of the rollers for guiding the telescopic jib and, on the other hand, the heavy rotary bearing for the jib has to be opened, so that again other precautions have to be taken which ensure that the entire jib is held securely during transport.

Furthermore, DE 33 43 343 A1 discloses a crane jib which can be telescoped and which is provided in particular in forest operation for the rapid movement of gripping tools which can be fitted to the free end of the jib. This telescopic jib, which comprises a basic box section and two inner box sections guided therein, can in turn be fixed to a lifting arm such that it can be pivoted hydraulically and thus moved. The lifting arm is in turn mounted on a pillar. The base box section of the telescopic jib, which is only about half as long as the two inner box sections, is open at both its ends, the inner box sections projecting rearward out of the base box section when retracted. In order to extend the inner box sections telescopically, a telescoping cylinder which projects considerably beyond the length of the base box section on both sides and is located on the outside is arranged longitudinally on the base box section, its extendable piston rod being attached to the free end at the head of the larger of the two inner box sections. In order to be able to extend the smaller inner box section at the same time as and at twice the speed of the larger inner box section, a pulling chain which extends over the entire length of the larger inner box section and circulates between two deflection points is provided, whose lower run has a fixing point on the base box section and whose upper run has a fixing point on the smaller inner box section. In order to be able to extend the two inner box sections together at lower speeds with a correspondingly increased telescoping force as required, provision is made in this crane jib to lock the two inner box sections to each other and to design one of the two fixing points for coupling the pulling chain to be releasable. In this case, however, the achievable telescope length corresponds only to the extended length of the larger inner box section. In the case of this crane jib, no provision is made for uncoupling the telescoping drive.

Finally, U.S. Pat. No. 3,828,941 discloses a vehicle having a working basket arranged on a jointed arm, which is additionally provided at the free end of the jointed arm with a working jib, which is formed by a short base box section and a single inner box section which is mounted therein and is more than twice as long and can be extended by a multi-stage hydraulic cylinder which is fitted to the outside of the base box section and whose piston rod is connected to the rear end of the inner box section. As compared with the length of the vehicle, the total length of the working jib forms only a small part. The hydraulic cylinder is connected to the basic box section both during working operation and during the transport of the vehicle.

It is an object of the present invention to develop a mobile crane of the generic type to the effect that, while maintaining the greatest possible telescoping length of the telescopic jib, and without the necessity to release the rotary bearing on the base box section, the overhang of the telescopic jib with respect to the chassis of the mobile crane does not exceed the permissible dimension in the transport position, and the expenditure on construction for this purpose is as low as possible.

According to the invention, this object is achieved by the features specified in patent claim 1. This mobile crane can advantageously be refined further by the features of the subclaims.

The present invention envisages leaving the mounting of the base box section of the telescopic jib in the working position unchanged in the transport position as well, that is to say to be mounted without the ability to be displaced longitudinally. In this case, the basic box section has a normal length corresponding to the permitted dimension of the overhang. However, at its foot end, in the vicinity of which its rotary bearing for raising the telescopic jib is arranged, it is open or can be opened in such a way that an opening exists there or is formed there and is sufficiently large that the outermost inner box section, that is to say the inner box section with the greatest cross section, can be led through this opening. The drive, located on the inside, with which the individual telescope sections, that is to say the inner box sections, can be extended and which therefore has to be supported with respect to the stationary basic box section, according to the invention can be released from its connection to the basic box section. Furthermore, the invention provides for a device to displace the inner box sections in the rear region behind the opening of the base box section. This therefore means that, for the transport, the entire pack of the inner box sections is displaced rearward by a certain amount through the opening at the foot end of the basic box section. In order to achieve the working position, this displacement is made reversible. This measure permits the inner box sections to be designed with a considerably greater length, as referred to the length of the base box section, without the permissible size of the front overhang of the telescopic jib being exceeded. As distinct from the prior art disclosed by DE 39 15 518 A1, according to the present invention, therefore, it is not the entire telescopic jib which is displaced rearward in order to achieve the transport position but only the pack of inner box sections. For this reason, it is not necessary to open the rotary bearing by which the telescopic jib is held. In addition, no additional rollers are required to guide the telescopic jib parts to be displaced. This is because the sliding guides which are present in the telescopic box sections in any case can be used for this purpose.

As already explained above, before the displacement of the pack of inner box sections, the connection to the base box section of the drive for telescoping the inner box sections out must be released. In an advantageous development of the invention, provision is therefore made to provide a coupling device for this connection of the drive, said device being constructed with the effect of a quick-action coupling, that is to say able to be released and engaged in the shortest possible time and with the least effort. The coupling device can preferably be operated mechanically.

The invention will be explained in more detail below using the exemplary embodiment illustrated in the figures, in which:

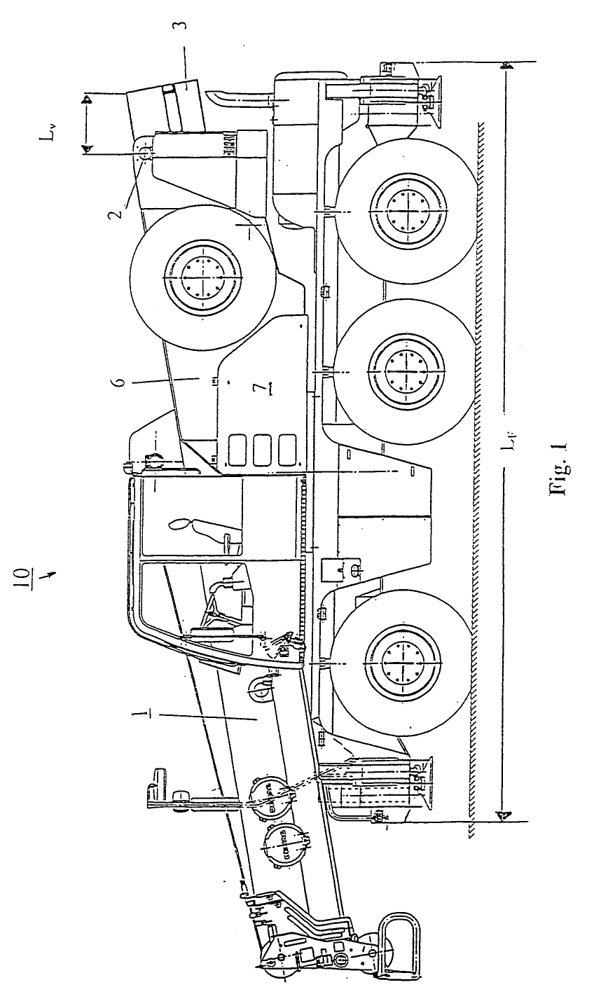

FIG. 1 shows the view of a mobile crane according to the invention,

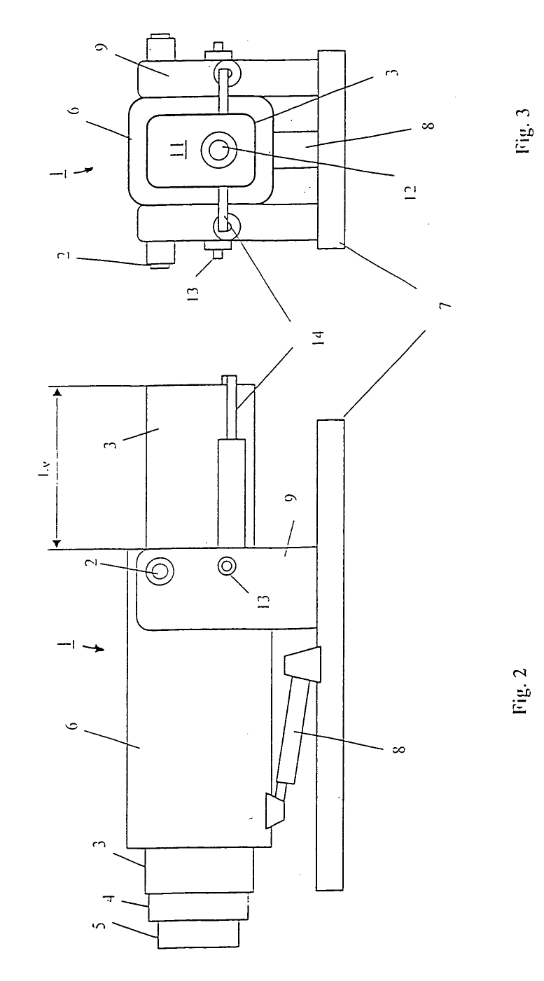

FIG. 2 shows a schematic side view of a telescopic jib of a mobile crane according to the invention and

FIG. 3 shows the rear view of the telescopic jib according to FIG. 2.

The mobile crane 10 illustrated by way of example in FIG. 1 has a telescopic jib 1 which toward the front is inclined slightly obliquely downward. This slight slope is used merely to improve the suitability for road traffic of the mobile crane 10, since it improves the visibility conditions for the driver. It has no influence on the essence of the invention and therefore, in the sense of the present invention, is further to be viewed as substantially horizontal. The telescopic jib is mounted on the superstructure 7 of the mobile crane 10 by means of a rotary joint 2. As can be seen at the front part of the telescopic jib 1, the telescopic jib 1 has a plurality of inner box sections telescoped into one another. The mobile crane 10 is shown in the transport position, in which the entire pack of inner box sections is displaced rearward through an opening in the base box section with respect to the undisplaceably mounted base box section 6 of the telescopic jib 1. This displacement travel is designated L_{V} in FIG. 1. The length of the chassis is designated L_{F}. If required, the displacement travel L_{V} could also be greater, so that a somewhat greater overhang of the telescopic jib 1 to the rear would also then occur. The overhang of the telescopic jib 1 in the front area has remained within the permitted limits as a result of the displacement of the inner box sections.

FIGS. 2 and 3 show that the base box section 6 of the telescopic jib 1 is rotatably mounted via a rotary joint 2 on bearing supports 9, which are in turn connected to the superstructure 7 of a mobile crane, not specifically illustrated. By means of a hydraulic tilting cylinder 8 attached via a rotary joint to the superstructure 7 and to the underside of the base box section, the telescopic jib 1 can be raised from the illustrated, substantially horizontal transport position into its working position. The telescopic jib 1 illustrated here has three inner box sections 3, 4, 5 which can be extended and retracted telescopically. At the foot of the jib, that is to say at the rear end of the base box section 6, in the vicinity of which the rotary joint 2 is located, the basic box section 6 is provided with an opening 11 which is sufficiently large that the outermost inner box section 3, which has the largest cross section of all the inner box sections, can be led through this opening 11. The latter is illustrated in FIG. 2. The displacement travel of the inner box section 3 from the basic position according to the working position into the transport function is again designated L_{V}. For the connection of the inner telescoping drive (telescopic cylinder 12) to the basic box section 6, for example bolted connections or the like which can be operated mechanically (for example hydraulically or electromechanically) are suitable. The reference symbol 13 designates an appropriate locking means. In order to displace the inner box sections 3, 4, 5 rearward into the transport position and back again into the working position, drives of a hydraulic or electromechanical type are likewise suitable. In FIGS. 1 to 3, such a displacement mechanism 14 has been illustrated in schematic form.

List of Reference Symbols:

1 telescopic jib

2 rotary joint

3 inner box section

4 inner box section

5 inner box section

6 base box section

7 superstructure

8 tilting cylinder

9 bearing supports

10 mobile crane

11 opening

12 telescoping cylinder

13 locking means

14 displacement device

L_{V} displacement travel

L_{F} length of the chassis

1. A mobile crane comprising a telescopic jib (1) that can be telescopically extended by means of a drive located on the inside, has a basic box section (6) that is connected via a rotary joint (2) to the superstructure (7) of the mobile crane (10) and has one or more sections (inner box sections 3, 4, 5) that can be extended and retracted telescopically and, by means of a tilting cylinder (8), can be erected from a substantially horizontal position for the transport into a working position, the telescopic jib (1), when retracted telescopically, being longer than the length of the chassis L_{F} and at least substantial telescopic parts of the telescopic jib (1), when retracted telescopically, being displaceable rearward in the substantially horizontal position with respect to the superstructure (7), so that the front overhang of the telescopic jib (1) with respect to the chassis of the mobile crane (10) is reduced, characterized
in that the basic box section (6) is mounted without longitudinal displaceability,
in that the basic box section (6) at its foot end is open or can be opened in such a way that the outermost inner box section (3) can be led through the opening (11) at the foot end,
in that the drive for the telescoping action can be released from its
connection to the basic box section (6),
in that a device (14) is provided for displacing the inner box sections (3, 4, 5) in the rear region behind the opening (11) of the basic box section (6), and
in that the inner box sections (3, 4, 5) are designed with an increased length as based on the length of the basic box section (6).

2. The mobile crane as claimed in claim 1, characterized in that, for the connection of the drive to the basic box section (6) a coupling device (locking means 13) that can be released and engaged in a short time with the effect of a quick-action coupling is provided.

3. The mobile crane as claimed in claim 2, characterized in that the coupling device can be operated mechanically.
